(19) United States
(12) Patent Application Publication
(10) Pub. No.: US 2006/0040643 A1
(43) Pub. Date: Feb. 23, 2006

(54) Mobile communication method and device for playing an audio file at a remote communication device

(76) Inventor: Edward O'Connor, London (GB)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/536,738

(22) PCT Filed: Oct. 29, 2003
(86) PCT No.: PCT/GB03/04659

§ 371 Date: May 27, 2005

(30) Foreign Application Priority Data
Nov. 28, 2002 (GB) 0227717.6

(51) Int. Cl. H04L 12/58

(52) U.S. Cl. 455/412.1; 455/414.4

(57) ABSTRACT

A method of configuring a mobile communication device for communication of audio files over a communications network via the download of program code, the method comprising storing the program code in a memory of the mobile communication device; obtaining an audio file; linking the audio file with an identifier associated with a remote receiving communication device; seeking to establish a connection with the remote receiving communication device using the identifier, and upon establishing a connection with the remoter communication device, opening the audio file from the memory of the mobile communication device and playing the audio file to the remote communication device.

The present invention relates to the field of mobile telephony and in particular to the transmission of audio messages from mobile communication devices to other communication devices.

Communication technology is a fast-paced industry, particularly with the advent of mobile communications. Mobile handsets have developed from very basic models, which essentially enabled only wireless speech to devices that can send text and picture messages to compatible terminals.

The service known as SMS (Short Message Service) provides mobile devices with the ability to send text messages from mobile to mobile. SMS prevents users from needlessly waiting for a call to be answered or speaking to an answering service if the called phone is busy or unavailable. Also, if the calling party does not wish to engage in conversation, SMS provides a mode of communication where conversation can be avoided.

SMS, however, has limitations, such as the need to manipulate and navigate a small multi-letter keypad, making the sending of text messages slow and often inconvenient. Text messages, due to their size restrictions and inconvenient mode of entry, are generally truncated forms of communication that restrict direct immediate expression and nuances normally easily conveyed by speech. Further, most hard-wired phones are not enabled to receive text messages, so it is a service essentially limited to mobile-to-mobile communication.

These limitations have been addressed in part by a service termed “interactive relay”. This service allows voice messages to be transmitted between mobile phones. In operation a caller wanting to send a voice message to another party firstly contacts a server via SMS. The server calls back to accept the message and the server then contacts the called person via SMS to notify them of the voice message. The called person then calls the server to collect the message. This service therefore has four stages and requires active interaction by both the caller and the called person with an intermediate agent, which is normally an automated internet server. A service of this type is described in European patent application number EP 1185068.

This service present problems for callers due to the need to input an SMS message and then await a response from a server which may be busy or unavailable, making sending the message slow and uncertain. It also presents problems for the called person due to their need to first read and decipher a text message and then call a server which may be busy or unavailable making the receipt of the message slow, expensive and uncertain.

Another approach is known as MMS (multimedia message service), which enables a caller with an MMS-compatible phone to compose a message with a combination of sound, text and pictures and send it to a called person's MMS-compatible phone.

A problem with this service is that it requires each party to possess an MMS-enabled phone to send and receive messages which are 2.5G or 3G phones. In other words, it is not possible to send an MMS message to a person without a compatible phone. As these phones are relatively new and expensive they are not yet in common usage. Therefore this service is restricted to a small minority of users for the present time and the near future.

A further problem with MMS is that since it is a multi-media technology, each message is classified and managed as a discrete data package whose cost of transmission is separate to and more expensive than a normal voice call and presently requires an additional subscription per month by any user.

It is an object of the present invention to overcome and/or alleviate at least one problem of the prior art.

According to one aspect, the present invention provides a mobile communication device for the communication of at least one audio file to a remote communication device over a communication network, the device comprising means for associating the at least one audio file with an identifier of the remote communication device; means for seeking a voice connection with the remote communication device via the identifier and means for playing the associated audio file across a voice connection, upon establishing the voice connection with the remote communication device.

This enables the communication device, such as a mobile telephone, to send voice/sound messages to any other remote communication device, including hard-wired telephones and mobile terminals, without the need of the recipient device to have compatibility requirements, and without the need of an intermediary server.

Therefore, this aspect of the invention advantageously provides a means for transmitting recorded voice and sound messages from a mobile device whereby the recipient communication device need only be enabled to receive telephone calls, so that all mobile telephones and fixed-line phones could receive the messages.

Further, this aspect of the invention provides a means for transmitting recorded voice and sound messages from a mobile device, which is simple, direct, fast, reliable and unidirectional.

Advantageously the invention provides a means for transmitting recorded voice and sound messages from a mobile device using existing networks and voice channels without requiring compatible handsets, as is required with MMS. The ability to prepare and send audible messages according to this invention is independent of the bearer and the configuration of the receiving device. The invention utilises existing networks and protocols.

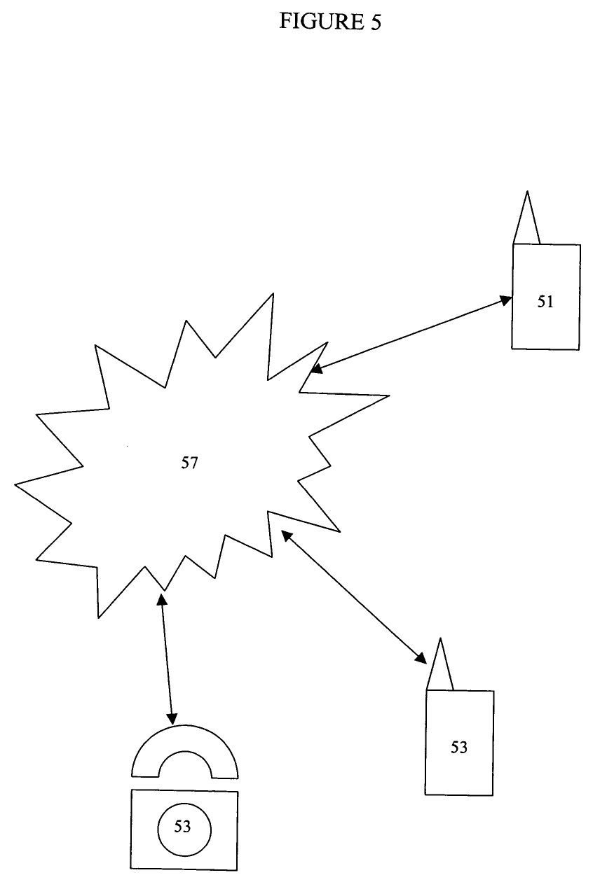

With reference to FIG. 5, all that is required, apart from a mobile terminal 51, such as a 2.5G to 3G mobile phone configured in accordance with the present invention, is that the receiving device, be it a landline device 53 or another mobile device 55, is in communicable relation with a communications network 57, be it a public switched telecommunications network (PSTN) or a cellular network, and configured to receive audible communications.

The invention therefore provides standard mobile communication devices with improved utility and enhanced functionality. In particular, this enhanced functionality is provided by another aspect of the invention, being a method of enabling a mobile communication device to communicate an audio file to a remote communication device, the method comprising associating the audio file with an identifier of the remote communication device; establishing a voice connection with the remote communication device using the identifier and, upon establishing the voice connection; playing the audio file across the connection.

According to a further aspect, the present invention provides a method of configuring a mobile communication device for communication of audio files over a communications network via the download of program code, the method comprising: storing the program code in a memory of the mobile communication device; obtaining an audio file; linking the audio file with an identifier associated with a remote receiving communication device; seeking to establish a connection with the remote receiving communication device using the identifier, and upon establishing a connection with the remoter communication device, opening the audio file from the memory of the mobile communication device and playing the audio file to the remote communication device.

According to a still further aspect, the present invention provides a carrier medium comprising processor readable code for controlling a processor in a mobile communications device in order to enable the device to communicate an audio file to a remote communication device, according to the following method: obtaining an audio file; linking the audio file with an identifier associated with the remote communication device; seeking to establish a connection with the remote communication device using the identifier, and upon establishing a connection with the remote communication device, opening the audio file and playing the audio file to the remote communication device.

These aspects of the present invention will now be described with reference to the accompanying drawings in which:

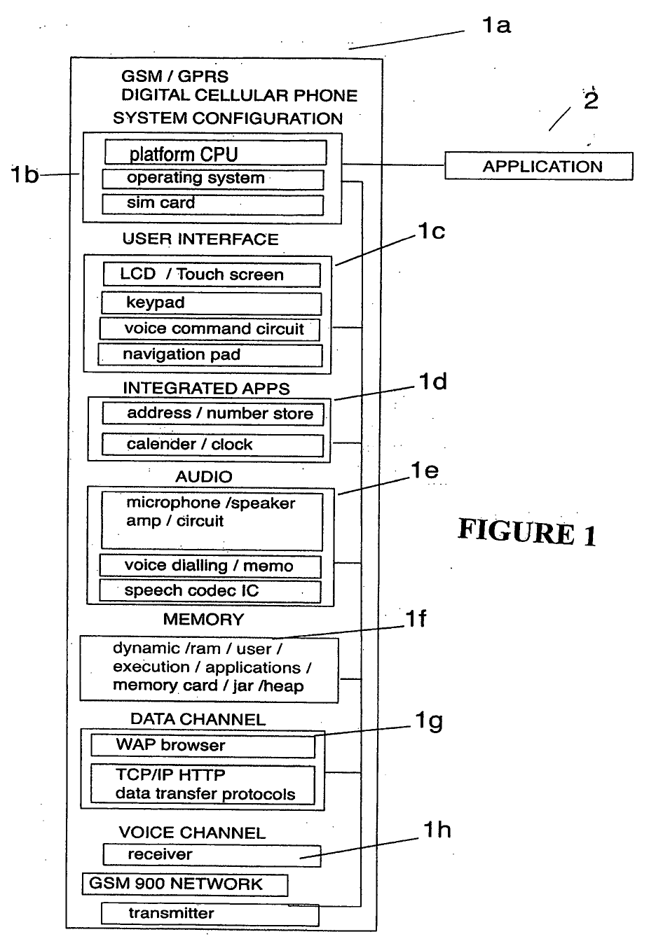

FIG. 1 illustrates schematically the components of a typical GSM/GPRS digital cellular phone.

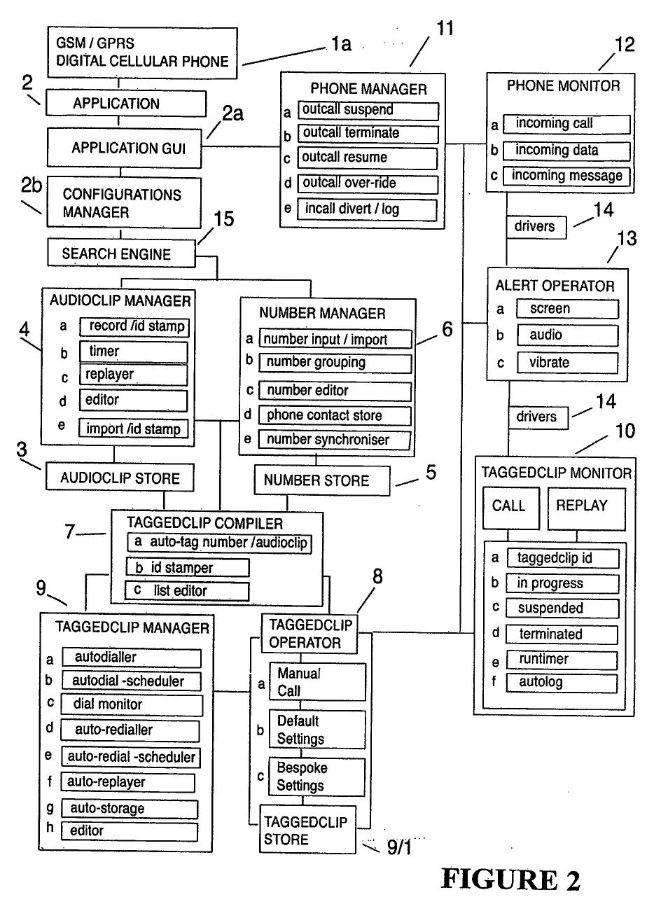

FIG. 2 illustrates schematically the functional components of an operating scheme according to one embodiment of the invention.

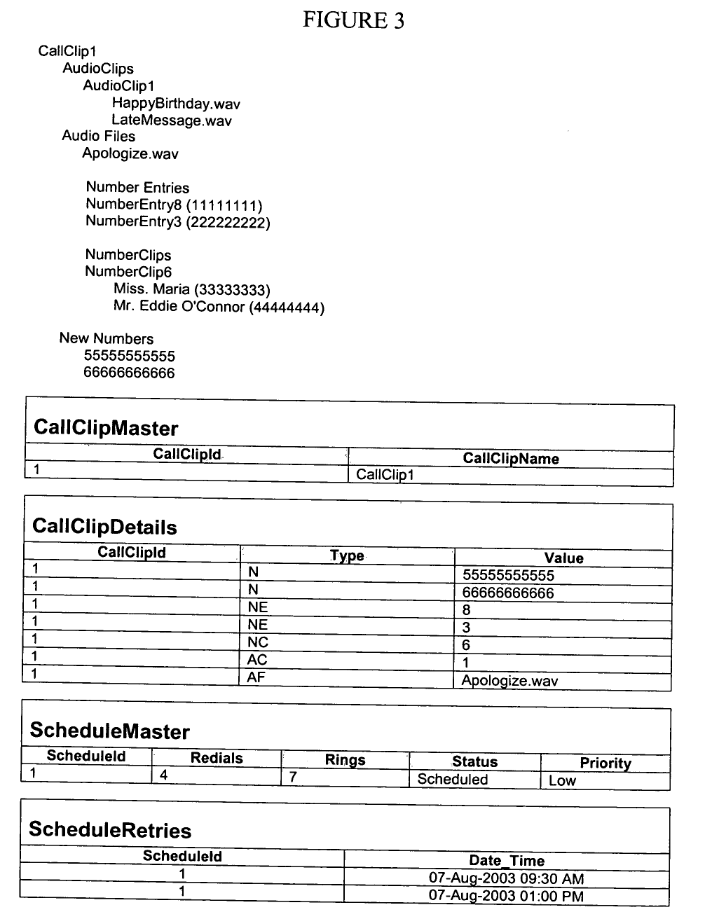

FIG. 3 illustrates an example of a TaggedClip file and the associated Schedules used for sending the TaggedClip according to an embodiment of the invention.

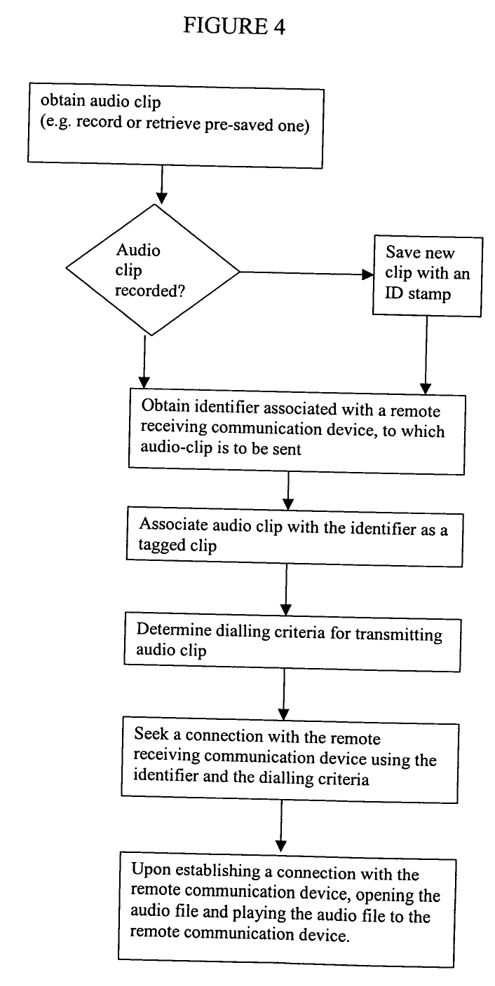

FIG. 4 illustrates a flow chart of a process according to an embodiment of the present invention.

FIG. 5 illustrates a schematic of a network in which the present invention may be utilised.

According to a first embodiment of the invention, the functionality of the present invention is achieved in the application layer of an existing mobile handset. That is, to enable an existing mobile handset to record and send voice messages the present invention is implemented in an application software program and run on the operating system of the phone.

As shown schematically in FIG. 1, the system configuration (1b) of a typical GSM/GPRS digital cellular phone is made up of a system platform with a CPU, an operating system, such as EPOC, Symbian, Pocket PC 2002 or Smartphone 2002, and a SIM card.

The program may be recorded on this operating system, or be recorded separately, such as on the SIM card, on a smart card, on the device's platform processor or any combination thereof.

The application may be written in any suitable code. Codes presently being utilised in the mobile telephony field include Java, Java 2 Micro Edition (J2ME), Personal Java Application Environment (PAE), C++, Visual Basic (VB), BREW and derivatives thereof.

The application program according to this embodiment, where possible, makes use of the mobile handset's memory and databases, so that when implemented on such a device it interacts with the existing facilities of the device.

In this regard, again referring to FIG. 1, a typical GSM/GPRS cellular phone includes a user interface (1c) incorporating an LCD screen and a keypad. The LCD screen may be a touch-screen. The user interface can also include other features, such as a voice command circuit and a navigation pad.

The audio features (1e) of the phone include a microphone and a speaker, both coupled to an amplifier circuit. The phone also supports voice dialling and also has voice memo capabilities and a speech CODEC integrated circuit.

Applications (1d) that are integrated with a typical GSM/GPRS phone include an address and number store, a calendar and a clock. The address and number store makes use of the phone's memory (1f), which can be of any type, and are generally a combination of dedicated and dynamic RAMs and can also include memory provided by SIM cards. In the number store, contact numbers and associated contact number names are stored. These numbers and names can be saved in various configurations, such as single, multiple, linked or sequential linked form so that they are accessible individually or in groups.

The phone also has voice channel receiver (1h) and a data channel receiver (1g) supporting a Wireless Access Protocol (WAP) browser and the TCP/IP HTTP data transfer protocol (1g).

Access and control of an application program embodying the present invention can be provided by modifying the Graphical User Interface (GUI) of the cellular phone on which the program is implemented. Alternatively, a dedicated application GUI can be provided. The GUI can provide user control using any suitable means, including touch screen capabilities, voice recognition control, a keypad, a navigation pad or any combination thereof. This will of course depend on the facilities provided by the handset itself.

With reference to FIG. 2, a configuration of the functional components of the application layer, which underlie the GUI (2a) program, according to one embodiment of the invention, will now be described.

Firstly there is a phone manager (11), which provides an incoming and outgoing call management facility. This component of the application program enables the user to manage and prioritise, manually or by default, phone operations such as incoming calls and data. For instance, such management can include the option to automatically trigger alerts, such as visual, audio and/or vibration alerts for incoming calls, the option to automatically suspend (11a) and subsequently resume (11c) non-priority application operations, such as an outgoing call, and the option to automatically terminate (11b) or automatically divert and log (11e) non-priority phone operations.

A component, herein termed a phone monitor (12), is associated with the phone manager (11) and the GUI (2a) and enables the status of any phone function or activity to be displayed on the phone screen and/or logged for later review. This application typically provides information such as the occurrence of incoming calls (12a), incoming data (12b) or incoming messages (12c). The phone function status may also be associated with an alert operator (13). In this way the alert operator can be activated, such as with an on-screen alert (13a), an audible alert (13b) and/or vibration (13c), in response to specified phone functions. These functions are provided on most modern mobile phones and will not be further described here.

One main function of the application program is to obtain an audio file or audio clip to be sent by the user of the mobile handset to a remote device, which may be another mobile handset or a fixed line phone of any configuration.

The audio-files and audio-clips are stored in an audio clip memory store (3), which is accessible by an audio-clip manager (4) component of the application program. The audio-files may contain voice or any other sounds originating externally to the phone, as well as sounds originating from internally within the phone. The internal sounds may be captured via an integrated speaker or an application based system that generates, synthesises or amplifies the sound.

An audio-file is intended to refer to a single audio entity, whereas an audio-clip is intended to refer to a group of audio-files. As audio-clips and audio-files may be used interchangeably by the application program, for ease, the expression “audio-clips” will be used to refer to either type, so that in in effect it is to be considered a group of one or more audio-files.

The audio clip manager (4) enables a user, via the GUI (3a), to manage and control the audio-clips, such as by providing the ability to record, edit and replay audio-clips. To provide these functions, the audio-clip manager (4) is associated with a number of different sub-components.

Firstly, an audio-clip recorder (4a) is associated with the audio-clip manager. This recorder is functionally connected to the internal microphone of the handset. Alternatively, a dedicated application based sound recording circuit could be used, but it is preferable to use the existing features of the cellular phone. The recorder (4a) can be used to record one or more audio-files. The audio file may contain a voice message, music, discrete sounds or a combination thereof. This audio file may be pre-recorded or recorded by the user. Therefore, the application program can allow such audio files to be created, such as by using one or more pre-recorded discrete sound samples or patterns. For instance, it may be possible to splice a number of audio files together. The discrete sound samples or patterns can be permanently or temporarily stored in a memory associated with the cellular phone. This memory is preferably separate from the memory store (3) where the audio-files are saved.

In addition, the recorder (4a) may capture voice or sounds generated during use of the handset for live calls made by or received by the handset.

An audio-clip importer (4e) is also associated with the audio-clip manager, which enables audio-clips to be imported, in whole or in part, from other memory sources within the handset or from external sources including remote sources via standard data transfer protocols, such as WAP, TCP-IP infrared and Bluetooth™.

An audio-clip identity (ID) stamper (4a, 4e) is also associated with the audio-clip manager. The identity stamper can provide each audio-clip with a name or label, whether the audio-clip is recorded on the handset, existing on the handset or imported. Hence the audio-clip ID stamper is coupled with both the audio-clip recorder (4a) and audioclip importer (4e). The creation of the ID stamp may be performed manually or automatically and the label may be of any type, including a numeric or alphanumeric string. The ID stamp of an audio-clip can be edited by way of deletion, alteration or replacement. It effectively acts as a reference for each audio-clip, so that the audio-clip manager can retrieve audio-clips as required.

An audio-clip timer (4b) is another sub-component of the audio-clip manager. This timer provides the facility whereby the duration of any audio-file may be recorded and made accessible to the user, such as visually. The timer may also provide information on the duration of any audio-file during recording and may also indicate available audio-file recording memory left at any time, such as prior to the recording, or even during or after the recording. The timer may also provide information on the duration of any audio-file previously recorded or imported. Where the length of an audio-file is determined, this information is stored alongside the file or in conjunction therewith.

An audio-clip replayer (4c) is also associated with the audio-clip manager, which provides a means to replay or reproduce any audio-clip or selected sequence of audio-clips. It is not essential that the replayed audio-clips be stored in the audio-clip store (3).

An audio-clip editor (4d) is also associated with the audio-clip manager, which enables created or stored audio-files to be manipulated, such as by shortening, adding to or splicing multiple audio-files together.

Once one or more audio-clips are created, the user can send these audio-clips to one or more remote devices, such as another mobile cellular phone or a landline device. To do this, the user utilises the GUI overlying the application program to “tag” one or more clips to be sent. These clips can be tagged temporarily or permanently, by associating one or more of the audio-clips with a contact number or a group of contact numbers. A contact number stored on the user's phone will be herein termed a “number Entry” and a group of numbers stored on the phone will be herein termed a “Number Clip”.

The management of such tagged clips is undertaken using a tagged clip manager (9) which is in communicable relation with the audio-clip manager (4) and the number manager (6) in order to retrieve the necessary data from the audio-clip store (3) and the number store (5).

Tagged clips are distinct from the audio-clips, as a new and distinct data reference is created. In this regard, a tagged-clip compiler (7) serves to tag number/audio-clip combinations using an ID stamper (7b). The ID stamp may be created manually or automatically and the ID stamp may be of any type, including a numeric or alphanumeric string. The ID stamp of the tagged-clip can be edited by way of deletion, alteration or replacement. It effectively acts as a reference for each tagged-clip, so that the Tagged-clip manager (9) can recall tagged-clips from the tagged-clip store (9/1) as required. With reference to FIG. 3, an example of a tagged clip is shown, labelled “CallClip1”.

A tagged-clip list editor (7c) is also associated with the tagged-clip compiler. Where a tagged-clip contains several Numbers Entries, Number Clips and/or several audio-clips, this list editor lists the sequence of numbers and/or audio-clips. The sequence can be determined by manual ordering by the user or on an automated default basis. These lists therefore record the order in which the audio-clips and respective number or numbers are used and accessed by the application program.

The tagged-clips are stored in a tagged-clip store (9/1) which is associated with the tagged-clip compiler (7) and the tagged-clip manager (9) either directly or indirectly, such as via a tagged-clip operator (8) as shown in FIG. 2. The tagged-clips may be stored temporarily or permanently in the store. Preferably the system of storage provides the ability to distinguish between any tagged-clip pending use and any tagged-clip post use.

The tagged-clip manager (9) manages and controls the communication of tagged-clips over the communication medium. In this regard, the tagged-clip manager has an auto-dialler (9a), which is configured to activate the automated dialling of any number or numbers within a tagged-clip. Where a tagged-clip has a plurality of numbers to which the audio-clip is to be sent, typically the auto-dialler will dial numbers in the sequence as saved by the list editor (7c). However, the user may decide an alternative sequence at any time prior to auto-dialling.

The tagged-clip manager (9) also has an auto-dial scheduler (9b), which provides means to schedule the operation of the auto-dialler. Preferably this is achieved with reference to a calendar and clock within the application, so that a user can schedule the auto-dialler at a particular future time on a particular day. Alternatively, auto-dialling may be scheduled at pre-set intervals. As shown in FIG. 3, the schedules entitled “ScheduleMaster” and “Schedule Retries” can assist the auto-dial scheduler with this functionality.

Preferably the auto-dial schedule list is viewable by the user on the GUI. In this way the user can amend the scheduled list (i.e. ScheduleMaster), such as by rearranging the order or cancelling any of the entries.

Another feature of the Tagged-clip manager (9) is a dial monitor (9c). The dial monitor monitors a call attempt and determines whether or not the call attempt fails. In this regard, the dial monitor can recognises when a given number is busy or otherwise unavailable. To achieve this, the dial monitor has an integrated ring counter such that when a pre-set or default number of rings to any number is exceeded, the call is automatically terminated. When an attempted call fails, the tagged-clip manager will reschedule the tagged-clip as appropriate (i.e. as per the default re-dialling details, or the user designated re-dialling details as is provided for in the ScheduleMaster in FIG. 3).

Where a given call fails, the auto-dialler may automatically initiate any further calls scheduled or sequential to the failed call, as listed in the AudioClip.

In a vein similar to the auto-dialler and the auto-dial scheduler (9b), the tagged-clip manager (9) also has an auto-redialler and an auto-redialler scheduler (9e), so that where the dial monitor (9c) registers that a tagged clip was not successfully transmitted, it is possible to re-dial the number as appropriate. In this regard, the auto-redialler may automatically redial any number on failure of a given call, or where the call is one of a sequence of numbers, it can redial immediately after the remaining uncalled numbers have been autodialed in their specified sequence.

Alternatively, the redialling may be configured as a single, multiple or continuous redial as specified by the user. For instance, the user may schedule one or more further attempts at particular points in time, or default re-dialling time periods may be defined, such as every ten minutes until the call is answered. An auto-redial scheduler (9e) associated with the auto-redialler (9d) provides the means for enabling the redialling of any terminated or failed calls of a tagged-clip number for any further date and time or at any pre-set interval. Referring to FIG. 3, the schedule entitled “Schedule Retries” lists the number of retries made or to be made in respect of a particular number to be called. In this regard, the scheduled audio-clip had two scheduled attempts on Aug. 7, 2003, one at 9.30AM and the other at 1pm. ScheduleMaster.

A schedule checking program is associated with the main application program. It preferably runs in the background and checks the “ScheduledRetries” table every minute to see if any calls are scheduled and due to be retried.

Further, the auto-redialler may prioritise any one or more failed calls, for example, so that the said call or calls are redialled continuously or at predetermined intervals until answered. With reference to FIG. 3, the “ScheduleMaster” assists with this functionality via the “priority” field. In addition, the auto-redialler may have a manual over-ride and/or a manual operating option.

Where a call connection is made, the tagged clip manager (9) activates the auto-replayer (9f). That is, the auto-replayer automatically triggers the replay of any audio-clip or sequence thereof contained with a tagged-clip when a number associated with the tagged-clip is called and answered by the called party. The replay of the audio-clip can be made repeatable.

A replay or call terminator may be associated with the audio-clip replayer, so that there is the optional facility for manual or default termination of any audio-clip communication. For instance, this may occur when a specified single or replay sequence is complete or when any communication is terminated by the called party, so as to ensure that the commencement of further tagged-clip calls which are scheduled are triggered.

Preferably a tagged-clip operator (8) is associated with the tagged-clip manager (9), which provides the user with the ability to override the automatic dialling and re-dialling routine. The tagged-clip operator therefore provides the user with the ability to manually initiate the calls (8a), whether based on default settings (8b) or bespoke settings (8c), at any time following a given tagged-clip compilation.

In addition, associated with the GUI (2a) is a tagged-clip monitor (10), which keeps track of the status of any tagged-clip, so that it can be displayed on the handset's screen and/or logged (10f) for later review. This component of the application program can therefore identify a tagged-clip (10a) being communicated visually on the handset's screen and also provide a status of the tagged-clip's communication, such as “scheduled”, “in progress” (10b), suspended (10c) or terminated (10d). With reference to FIG. 3, the ScheduleMaster can assist with this functionality via the “Status” field. The tagged-clip monitor (10) can also provide a run-timer (10e) so that it is visually possible to determine, for example, who long the tagged-clip has been in progress and/or how much longer the tagged-clip has to play.

The tagged-clip monitor (10) can also be used to display the progress of audio-clip replays (4c). It may also be associated with the alert operator (13) to provide, for example, an audible, visual or vibrational alert upon completion of a tagged-clip communication.

To describe the operation of a mobile handset incorporating the application program according to an embodiment of the invention, reference is to be made to FIG. 4, which shows a flow chart of the procedure for sending tagged-clips to remote devices.

The first step (31) is for the user to obtain an audio clip or clips to be sent to one or more remote devices. This may entail the user selecting an existing audio-clip, such as a pre-recorded message, or the user may record their own audio-clip, such as a voice message.

If a new clip is created, the audio-clip will then be saved with an ID stamp (4a), as controlled by the audio-clip manager. This may be performed automatically, although the user is preferably given an opportunity to personalise the label associated with the audio-clip, such as “Voice Message for Alissa” or “HappyBirthday.wav” and “LateMessage.wav”, as per the examples in FIG. 3.

Where the audio clip selected by the user is an existing one, the user is again preferably given an opportunity to personalise the label associated with the audio-clip. It is also preferable that the selected audio-clip is copied from a read-only memory of pre-recorded clips store to a separate audio-clip store (3), to ensure that the pre-recorded files are available for subsequent use and are not able to be accidentally deleted.

Once the user has obtained the audio-clip or clips, an identifier of a remote terminal or terminals, to which the audio-clip is to be sent, is determined. For instance, the user selects the phone number of the remote terminal to which the clip is to be sent. This is can be performed at the application level using a search engine (15) that searches the number store (5) for the appropriate Number Entry or NumberClip, although the user may simply enter the number manually.

It is to be appreciated that while this embodiment of the invention will be described only in relation to one clip being sent to one remote terminal, multiple clips to multiple different remote terminals, and any other such combination is possible within the inventive concept, as shown in the FIG. 3 example.

With the remote terminal to which the clip is to be sent identified, this identity is associated with the audio-clip, either directly or indirectly. In the FIG. 3 example, the clips and numbers are saved as a file entitled “CallClip1”.

The user may then determine dialling criteria for transmitting the file to the remote terminal. For instance, the user may schedule dialling to take place at 5pm that day and then schedule five reattempts at ten minute intervals thereafter should the call go unanswered or the call fail for whatever other reason. Alternatively a default setting may be implemented.

The selected audio-clip and remote terminal number are linked and stored as a tagged-clip in a tagged-clip store, and the dialling criteria is stored in a schedule associated with the store (9/1). In this regard, where a plurality of tagged-clips are to be sent, they are preferably stored in the schedule in time-order. Other prioritisation may be applied to the schedule, such as by flagging audio-clips as urgent or standard.

The use of the time-based schedule means that the sending of the tagged-clips need not be user initiated, although this can be an option. The ability to schedule a message at a specific time is particularly advantageous when leaving messages in a different time domain, in that a time convenient to the recipient can be scheduled.

Therefore, the application program will monitor a clock associated with the mobile device and the next scheduled time of a tagged-clip to be sent in the linked list. When a match occurs, the application program will retrieve the linked tagged-clip and dial the number of the remote device associated therewith.

A dial monitor will monitor the status of the connection.

Should a connection not be established, the dialling will be terminated, and the tagged-clip rescheduled at a later time for redialling, as determined previously, either by the user or the default settings.

When the dial monitor registers that a connection has been established with a dialled number, the auto-replayer is initiated in order to play the audio-clip associated with the dialled number down the connection. That is the audio-clip is supplied to the transmitter of the handset for transmission across the network connection.

The application program monitors the audio-clip and when it is finished the established communication is disconnected. The audio-clip may be monitored as finished using the time stamp associated therewith.

Where two or more files are to be sent to the one dialled number, instead of disconnecting at the completion of the first audio-clip, the connection is maintained, and the subsequent files retrieved and transmitted.

An example of schedules that can assist with the functionality of the application program components, are shown in FIG. 3.

Firstly, FIG. 3 shows the structure of an example TaggedClip, called CallClip1. CallClip1 contains files made up of a multiple audio messages, termed “Audioclips”, as well as single audio messages, called “Audio Files”. In this example, under the “AudioClip” section, AudioClip1 is saved, which is made up of two messages “HappyBirthday.wav” and “LateMessage.wav”, as well as a single Audio File, which is made up of “Apologise.wav”.

The TaggedClip, CallClip1 also comprises several numbers to which the AudioClips and Audio Files are to be sent. These numbers can be any of three different types. They may be a “Number Entry”, which relates to a number already entered and stored on the phone, a “Number Clip” which relates to a plurality of numbers stored in the phone as a group or they may be a “New Number”, which is a number entered by the user and typically not already stored.

This information can be stored in a number of Schedules. As shown in FIG. 3, the “CallClipMaster” and “CallClipDetails” contain information about the TaggedClip, “CallClip1”. The “CallClipMaster” contains a list of all outstanding TaggedClips. It has two fields, CallClipID and CallClipName. As shown in FIG. 3, with this example, CallClip1 is given the CallClipID of “1” and its name “CallClip1” is entered as the “CallClipName”.

The Schedule “CallClipDetails” is associated with the schedule “CallClipMaster”. In this regard, its first table entry is “CallClipID”, which corresponds with the CallClipID of the CallClipMaster. The other fields in this Schedule are “Type” and “Value”. The “Type” field defines the value, be it an “Audio Clip”, an “Audio File” or a “New Number” etc.

In the type field, “N” stands for a “New Number”, NE stands for a “Number Entry”, NC stands for a “Number Clip”, AC stands for an “Audio Clip” and AF stands for an “Audio File”.

Referencing back to the structure of CallClip1 given in FIG. 3, this TaggedClip contained two new numbers, being “55555555555” and “6666666666”. These two new numbers are therefore stored in the “CallClipDetails” schedule as type “N” and with values “55555555555” and “6666666666” respectively.

CallClip1 also has two “Number Entries”, being Number Entries 8 and 3. These are stored in the CallClipDetails schedule as type “NE” with values 8 and 3 respectively. These “Number Entries” reference an actual phone number in the phone's memory.

CallClip1 also has one Number Clip, being NumberClip 6. This is therefore stored in the CallClipDetails schedule as type “NC” and value “6”.

CallClip1 also has one Audio Clip, being AudioClip 1. This is therefore stored in the CallClipDetails schedule as type “AC” and value “1”.

Finally, CallClip1 also has one Audio File, being “Apologize.wav”. This is therefore stored in the CallClipDetails schedule as type “AC” and value “Apologize.wav”.

With this TaggedClip saved as such, it is also necessary to associate the TaggedClip with scheduling details for the Audio Clips and Files to be communicated to the designated numbers. In this regard, the ScheduleMaster contains the fields “ScheduleID”, “Redials”, “Rings”, “Status and “Priority”.

The ScheduleID can be the same as the CallClipID, in that it refers to the taggedclip as a whole or it can refer to specific audio-clips or files within the tagged clip. The “Redials” field defines the number of times the TaggedClip Manager (9) will attempt to connect with the party to be called, such that in the event of the number being busy or going unanswered. The “Rings” field defines the number of rings to be made until the attempted connection is considered unanswered. The “Status” filed indicates, for instance, whether call is “scheduled”, or underway. The “priority” filed allows a person to designate some calls as more important than others.

The TaggedClip Manager (9) would therefore use the information in these schedules (as well as other schedules) and update as appropriate.

For instance, the Dial Monitor (9c) component of the TaggedClip Manager would continually poll the “ScheduledRetries” table to find any record which has its “Date-Time” value in the past and its corresponding record in the “ScheduleMaster” table has the status as “scheduled”, or “waiting to retry”. As soon as it finds any such record, it changes the status of the record in the “ScheduleMaster table to “In progress”.

The Dial Monitor (9c) then dials the numbers from “CallClipDetails” table one after the other. IF there are any numbers which have not been dialled successful, it redials the failed numbers. But before redialling the failed numbers it changes the status of the record in the “ScheduleMaster” table to “Waiting for Redial” and picks up another schedule for processing.

If all the numbers are dialled successfully in the first attempt, or in the redials, then the status of the record in ScheduleMaster is changed to “Success”.

If all the numbers are not dialled successfully in the first attempt or subsequent redials, the “ScheduleRetries” table is checked to see whether any retry entries for that current schedule are specified. IF there is a retry entry, then it changes the status of the record in the ScheduleMaster table to “Waiting for Retry”. If there is no retry entry specified, then it changes stats of the record in the ScheduleMaster table to “Failed”.

According to a further embodiment of the invention, rather than disconnecting at the completion of the playing of the audio-clips, the application program allows the called party to respond to the message. That is, the application program can prompt the called party to record a reply, if desired. The application would then start recording any spoken reply by the called party across the connection.

Further, according to another embodiment, each time a connection is established, a fixed message is communicated across the connection before the audio-clip is communicated. This enables the application program to address the situation where an answering machine picks up at the other end, rather than a person, and has an automated message before allowing recording to commence, particularly since the mobile handset on which the application is configured cannot necessarily do so. The length of the fixed message should be selected in order to maximise the likelihood of the personal message being recorded in full.

Therefore the length of the fixed message should be strategically determined on the basis of the maximum length of answering machine messages. Therefore, even if an answering machine starts its replayed message, it is likely that it will be the playing of the fixed message that corresponds therewith, and that the answering machine's message will be exhausted in time for the personal message to still be recorded. According to a further embodiment, the fixed message could be played before the personal message, and then this combination again repeated. In this way the personal message should be recorded in full at least once on the answering machine.

An alternative feature, which also addresses the answering machine problem is to introduce a delay to the delivery of the message when it is detected that an answering machine has answered rather than a person. The delay is intended to postpone the playback until the answering machine has finished delivering its own message and recording started.

A further feature that an embodiment of the present invention may provide is that of call interruption. That is, the application program can allow incoming calls to override outgoing schedules and also allow outgoing calls to override outgoing schedules. This feature is important when it is considered that the nature of the present invention implemented on a mobile phone means that a balance needs to be struck between the usage of the mobile phone for its normal purposes and for transmission of the audio-clips, particularly since a dedicated line is not normally provided.

An additional feature that an embodiment of the present invention may provide, once a call is established, is for the microphone on the caller's phone to be muted. This is so that the called party doesn't receive any sounds from the calling phone, apart from the audio-clip itself. It is also preferable that the speaker on the caller's phone is muted, so that the calling party does not hear the outgoing message.

On a Nokia 7650 phone, this can be achieved by using the inbuilt functionality of the device. In this regard, when the call is connected, a Nokia 7650 phone opens up a default window known as the “Call Window”. The Call Window has its own menu items, one of which is “Mute”. Therefore, once this window is opened, the application program sends a series of key-strokes to select the “Mute” menu item. Once selected, this function serves to mute the phone by switching off the microphone, so that the called device hears no external sound. This muting, however does not affect the called device hearing the audio-clips played across the connection.

The procedure just described specifically relates to the Nokia 7650. For other phones, equivalent functionality would need to be achieved.

As mentioned previously, the application program of this embodiment, where possible, makes use of the existing facilities of the phone, including the phone's operating system. To illustrate this, an example of the implementation of the dial monitor, where the Symbian operating system is utilised, will be described. The dial monitor functionality can be achieved using the existing functionality of Symbian. More specifically, Symbian provides the mechanisms of Active Scheduler and Active Objects. Active Objects are present inside the Active Scheduler and can be used to make an asynchronous request, like dialling a number. As soon as any Active Object makes an asynchronous request, Active Scheduler takes over the control for monitoring the status of that asynchronous request. When the asynchronous request is completed, Active Scheduler informs the Active Object which made the request, of the completion of the request.

In this way, the dial monitor can use the Active Object and Active Scheduler to dial the number, monitor the status of the call and hang up the call.

Therefore, when the dial monitor has to dial a number it opens the voice line and requests an Active Object to dial the number. The Active Object passes that request on and the number is dialled through telephony APIs (Application Program Interfaces) provided by Symbian. At this point the Active Scheduler starts monitoring for the completion of the request.

When dialling is complete, either successfully or unsuccessfully, Active Scheduler informs the Active Object of the same. While doing so, it passes the status of the dialling to the Active Object. The application program of the present embodiment is then able to utilise this status for its own further processing.

For instance, if the status is “connected” then the application program plays the audio message. If the status is unknown” then the application program hangs up the call.

It is to be appreciated that opening of the audio file, playing of the audio file and closing of the audio file are other functions that can be undertaken within an active object.

Therefore, the statuses of audio files being played can be monitored in the same way as the line connection process.

Once all the audio files have been played, the Active Object makes an asynchronous request to the device to hang up the call. At this point the Active Scheduler starts monitoring for the completion of the hang-up request. As soon as the call has been hung up, the Active Scheduler informs the Active Object of the same, along with the status of the hang-up request. The Active Object then closes the voice line when it has been notified that the call has been hung-up.

Alterations and additions are possible within the general inventive concepts. The embodiments of the intention are to be considered as illustrations of the inventions and not necessarily limiting on the general inventive concepts.

For example, the present invention has been described in relation to a GSM/GPRS enabled phone, but any other mobile terminal may be used, provided its memory requirements are sufficient to support an application program embodying the invention. In practice, it has been found that at least a 2.5G to 3G mobile handset is required. Personal Digital Assistants (PDAs) and other such devices able to access mobile communications networks may also be configured to utilise the present invention.

Further, the embodiments of the invention have described only one call connection being established to transmit the tagged-clips at one time. While this most typically within the capabilities of existing handsets, it is not outside the scope of the invention to establish multiple connections at one time.

Also, the components as described in the preferred embodiments provide only an example of how a mobile terminal may be configured to perform the functional aspects of the invention.

The skilled person will appreciate that the precise implementation of the application program of the present invention will depend on the application program interfaces (APIs) utilised. This is because different APIs, which are the specific methods prescribed by a computer operating system by which a person writing an application program can make requests of the operating system or another application, will be utilised for different operating systems.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FP GA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analog array or similar device in order to configure analog hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

### Mobile Telephony Method and Associated System

The present invention relates to the field of mobile telephony and in particular to the transmission of audio messages from mobile communication devices to other communication devices.

Communication technology is a fast-paced industry, particularly with the advent of mobile communications. Mobile handsets have developed from very basic models, which essentially enabled only wireless speech to devices that can send text and picture messages to compatible terminals.

The service known as SMS (Short Message Service) provides mobile devices with the ability to send text messages from mobile to mobile. SMS prevents users from needlessly waiting for a call to be answered or speaking to an answering service if the called phone is busy or unavailable. Also, if the calling party does not wish to engage in conversation, SMS provides a mode of communication where conversation can be avoided.

SMS, however, has limitations, such as the need to manipulate and navigate a small multi-letter keypad, making the sending of text messages slow and often inconvenient. Text messages, due to their size restrictions and inconvenient mode of entry, are generally truncated forms of communication that restrict direct immediate expression and nuances normally easily conveyed by speech. Further, most hard-wired phones are not enabled to receive text messages, so it is a service essentially limited to mobile-to-mobile communication.

These limitations have been addressed in part by a service termed “interactive relay”. This service allows voice messages to be transmitted between mobile phones. In operation a caller wanting to send a voice message to another party firstly contacts a server via SMS. The server calls back to accept the message and the server then contacts the called person via SMS to notify them of the voice message. The called person then calls the server to collect the message. This service therefore has four stages and requires active interaction by both the caller and the called person with an intermediate agent, which is normally an automated internet server. A service of this type is described in European patent application number EP 1185068.

This service present problems for callers due to the need to input an SMS message and then await a response from a server which may be busy or unavailable, making sending the message slow and uncertain. It also presents problems for the called person due to their need to first read and decipher a text message and then call a server which may be busy or unavailable making the receipt of the message slow, expensive and uncertain.

Another approach is known as MMS (multimedia message service), which enables a caller with an MMS-compatible phone to compose a message with a combination of sound, text and pictures and send it to a called person's MMS-compatible phone.

A problem with this service is that it requires each party to possess an MMS-enabled phone to send and receive messages which are 2.5G or 3G phones. In other words, it is not possible to send an MMS message to a person without a compatible phone. As these phones are relatively new and expensive they are not yet in common usage. Therefore this service is restricted to a small minority of users for the present time and the near future.

A further problem with MMS is that since it is a multi-media technology, each message is classified and managed as a discrete data package whose cost of transmission is separate to and more expensive than a normal voice call and presently requires an additional subscription per month by any user.

It is an object of the present invention to overcome and/or alleviate at least one problem of the prior art.

According to one aspect, the present invention provides a mobile communication device for the communication of at least one audio file to a remote communication device over a communication network, the device comprising means for associating the at least one audio file with an identifier of the remote communication device; means for seeking a voice connection with the remote communication device via the identifier and means for playing the associated audio file across a voice connection, upon establishing the voice connection with the remote communication device.

This enables the communication device, such as a mobile telephone, to send voice/sound messages to any other remote communication device, including hard-wired telephones and mobile terminals, without the need of the recipient device to have compatibility requirements, and without the need of an intermediary server.

Therefore, this aspect of the invention advantageously provides a means for transmitting recorded voice and sound messages from a mobile device whereby the recipient communication device need only be enabled to receive telephone calls, so that all mobile telephones and fixed-line phones could receive the messages.

Further, this aspect of the invention provides a means for transmitting recorded voice and sound messages from a mobile device, which is simple, direct, fast, reliable and unidirectional.

Advantageously the invention provides a means for transmitting recorded voice and sound messages from a mobile device using existing networks and voice channels without requiring compatible handsets, as is required with MMS. The ability to prepare and send audible messages according to this invention is independent of the bearer and the configuration of the receiving device. The invention utilises existing networks and protocols.

With reference to FIG. 5, all that is required, apart from a mobile terminal 51, such as a 2.5G to 3G mobile phone configured in accordance with the present invention, is that the receiving device, be it a landline device 53 or another mobile device 55, is in communicable relation with a communications network 57, be it a public switched telecommunications network (PSTN) or a cellular network, and configured to receive audible communications.

The invention therefore provides standard mobile communication devices with improved utility and enhanced functionality. In particular, this enhanced functionality is provided by another aspect of the invention, being a method of enabling a mobile communication device to communicate an audio file to a remote communication device, the method comprising associating the audio file with an identifier of the remote communication device; establishing a voice connection with the remote communication device using the identifier and, upon establishing the voice connection, playing the audio file across the connection.

According to a further aspect, the present invention provides a method of configuring a mobile communication device for communication of audio files over a communications network via the download of program code, the method comprising: storing the program code in a memory of the mobile communication device; obtaining an audio file; linking the audio file with an identifier associated with a remote receiving communication device; seeking to establish a connection with the remote receiving communication device using the identifier, and upon establishing a connection with the remoter communication device, opening the audio file from the memory of the mobile communication device and playing the audio file to the remote communication device.

According to a still further aspect, the present invention provides a carrier medium comprising processor readable code for controlling a processor in a mobile communications device in order to enable the device to communicate an audio file to a remote communication device, according to the following method: obtaining an audio file; linking the audio file with an identifier associated with the remote communication device; seeking to establish a connection with the remote communication device using the identifier, and upon establishing a connection with the remote communication device, opening the audio file and playing the audio file to the remote communication device.

These aspects of the present invention will now be described with reference to the accompanying drawings in which:

FIG. 1 illustrates schematically the components of a typical GSM/GPRS digital cellular phone.

FIG. 2 illustrates schematically the functional components of an operating scheme according to one embodiment of the invention.

FIG. 3 illustrates an example of a TaggedClip file and the associated Schedules used for sending the TaggedClip according to an embodiment of the invention.

FIG. 4 illustrates a flow chart of a process according to an embodiment of the present invention.

FIG. 5 illustrates a schematic of a network in which the present invention may be utilised.

According to a first embodiment of the invention, the functionality of the present invention is achieved in the application layer of an existing mobile handset. That is, to enable an existing mobile handset to record and send voice messages the present invention is implemented in an application software program and run on the operating system of the phone.

As shown schematically in FIG. 1, the system configuration (1b) of a typical GSM/GPRS digital cellular phone is made up of a system platform with a CPU, an operating system, such as EPOC, Symbian, Pocket PC 2002 or Smartphone 2002, and a SIM card.

The program may be recorded on this operating system, or be recorded separately, such as on the SIM card, on a smart card, on the device's platform processor or any combination thereof.

The application may be written in any suitable code. Codes presently being utilised in the mobile telephony field include Java, Java 2 Micro Edition (J2ME), Personal Java Application Environment (PJAE), C++, Visual Basic (VB), BREW and derivatives thereof.

The application program according to this embodiment, where possible, makes use of the mobile handset's memory and databases, so that when implemented on such a device it interacts with the existing facilities of the device.

In this regard, again referring to FIG. 1, a typical GSM/GPRS cellular phone includes a user interface (1c) incorporating an LCD screen and a keypad. The LCD screen may be a touch screen. The user interface can also include other features, such as a voice command circuit and a navigation pad.

The audio features (1e) of the phone include a microphone and a speaker, both coupled to an amplifier circuit. The phone also supports voice dialling and also has voice memo capabilities and a speech CODEC integrated circuit.

Applications (1d) that are integrated with a typical GSM/GPRS phone include an address and number store, a calendar and a clock. The address and number store makes use of the phone's memory (1f), which can be of any type, and are generally a combination of dedicated and dynamic RAMs and can also include memory provided by SIM cards. In the number store, contact numbers and associated contact number names are stored. These numbers and names can be saved in various configurations, such as single, multiple, linked or sequential linked form so that they are accessible individually or in groups.

The phone also has voice channel receiver (1h) and a data channel receiver (1g) supporting a Wireless Access Protocol (WAP) browser and the TCP/IP HTTP data transfer protocol (1g).

Access and control of an application program embodying the present invention can be provided by modifying the Graphical User Interface (GUI) of the cellular phone on which the program is implemented. Alternatively, a dedicated application GUI can be provided. The GUI can provide user control using any suitable means, including touch screen capabilities, voice recognition control, a keypad, a navigation pad or any combination thereof. This will of course depend on the facilities provided by the handset itself.

With reference to FIG. 2, a configuration of the functional components of the application layer, which underlie the GUI (2a) program, according to one embodiment of the invention, will now be described.

Firstly there is a phone manager (11), which provides an incoming and outgoing call management facility. This component of the application program enables the user to manage and prioritise, manually or by default, phone operations such as incoming calls and data. For instance, such management can include the option to automatically trigger alerts, such as visual, audio and/or vibration alerts for incoming calls, the option to automatically suspend (11a) and subsequently resume (11c) non-priority application operations, such as an outgoing call, and the option to automatically terminate (11b) or automatically divert and log (11e) non-priority phone operations.

A component, herein termed a phone monitor (12), is associated with the phone manager (11) and the GUI (2a) and enables the status of any phone function or activity to be displayed on the phone screen and/or logged for later review. This application typically provides information such as the occurrence of incoming calls (12a), incoming data (12b) or incoming messages (12c). The phone function status may also be associated with an alert operator (13). In this way the alert operator can be activated, such as with an on-screen alert (13a), an audible alert (13b) and/or vibration (13c), in response to specified phone functions. These functions are provided on most modern mobile phones and will not be further described here.

One main function of the application program is to obtain an audio file or audio clip to be sent by the user of the mobile handset to a remote device, which may be another mobile handset or a fixed line phone of any configuration.

The audio-files and audio-clips are stored in an audio clip memory store (3), which is accessible by an audio-clip manager (4) component of the application program. The audio-files may contain voice or any other sounds originating externally to the phone, as well as sounds originating from internally within the phone. The internal sounds may be captured via an integrated speaker or an application based system that generates, synthesises or amplifies the sound.

An audio-file is intended to refer to a single audio entity, whereas an audio-clip is intended to refer to a group of audio-files. As audio-clips and audio-files may be used interchangeably by the application program, for ease, the expression “audio-clips” will be used to refer to either type, so that in in effect it is to be considered a group of one or more audio-files.

The audio clip manager (4) enables a user, via the GUI (3a), to manage and control the audio-clips, such as by providing the ability to record, edit and replay audio-clips. To provide these functions, the audio-clip manager (4) is associated with a number of different sub-components.

Firstly, an audio-clip recorder (4a) is associated with the audio-clip manager. This recorder is functionally connected to the internal microphone of the handset. Alternatively, a dedicated application based sound recording circuit could be used, but it is preferable to use the existing features of the cellular phone. The recorder (4a) can be used to record one or more audio-files. The audio file may contain a voice message, music, discrete sounds or a combination thereof. This audio file may be pre-recorded or recorded by the user. Therefore, the application program can allow such audio files to be created, such as by using one or more pre-recorded discrete sound samples or patterns. For instance, it may be possible to splice a number of audio files together. The discrete sound samples or patterns can be permanently or temporarily stored in a memory associated with the cellular phone. This memory is preferably separate from the memory store (3) where the audio-files are saved.

In addition, the recorder (4a) may capture voice or sounds generated during use of the handset for live calls made by or received by the handset.

An audio-clip importer (4e) is also associated with the audio-clip manager, which enables audio-clips to be imported, in whole or in part, from other memory sources within the handset or from external sources including remote sources via standard data transfer protocols, such as WAP, TCP-IP infrared and Bluetooth™.

An audio-clip identity (ID) stamper (4a, 4e) is also associated with the audio-clip manager. The identity stamper can provide each audio-clip with a name or label, whether the audio-clip is recorded on the handset, existing on the handset or imported. Hence the audio-clip ID stamper is coupled with both the audio-clip recorder (4a) and audio-clip importer (4e). The creation of the ID stamp may be performed manually or automatically and the label may be of any type, including a numeric or alphanumeric string. The ID stamp of an audio-clip can be edited by way of deletion, alteration or replacement. It effectively acts as a reference for each audio-clip, so that the audio-clip manager can retrieve audio-clips as required.

An audio-clip timer (4b) is another sub-component of the audio-clip manager. This timer provides the facility whereby the duration of any audio-file may be recorded and made accessible to the user, such as visually. The timer may also provide information on the duration of any audio-file during recording and may also indicate available audio-file recording memory left at any time, such as prior to the recording, or even during or after the recording. The timer may also provide information on the duration of any audio-file previously recorded or imported. Where the length of an audio-file is determined, this information is stored alongside the file or in conjunction therewith.

An audio-clip replayer (4c) is also associated with the audio-clip manager, which provides a means to replay or reproduce any audio-clip or selected sequence of audio-clips. It is not essential that the replayed audio-clips be stored in the audio-clip store (3).

An audio-clip editor (4d) is also associated with the audio-clip manager, which enables created or stored audio-files to be manipulated, such as by shortening, adding to or splicing multiple audio-files together.

Once one or more audio-clips are created, the user can send these audio-clips to one or more remote devices, such as another mobile cellular phone or a landline device. To do this, the user utilises the GUI overlying the application program to “tag” one or more clips to be sent. These clips can be tagged temporarily or permanently, by associating one or more of the audio-clips with a contact number or a group of contact numbers. A contact number stored on the user's phone will be herein termed a “Number Entry” and a group of numbers stored on the phone will be herein termed a “Number Clip”.

The management of such tagged clips is undertaken using a tagged clip manager (9) which is in communicable relation with the audio-clip manager (4) and the number manager (6) in order to retrieve the necessary data from the audio-clip store (3) and the number store (5).

Tagged clips are distinct from the audio-clips, as a new and distinct data reference is created. In this regard, a tagged-clip compiler (7) serves to tag number/audio-clip combinations using an ID stamper (7b). The ID stamp may be created manually or automatically and the ID stamp may be of any type, including a numeric or alphanumeric string. The ID stamp of the tagged-clip can be edited by way of deletion, alteration or replacement. It effectively acts as a reference for each tagged-clip, so that the Tagged-clip manager (9) can recall tagged-clips from the tagged-clip store (9/1) as required. With reference to FIG. 3, an example of a tagged clip is shown, labelled “CallClip 1”.

A tagged-clip list editor (7c) is also associated with the tagged-clip compiler. Where a tagged-clip contains several Numbers Entries, Number Clips and/or several audio-clips, this list editor lists the sequence of numbers and/or audio-clips. The sequence can be determined by manual ordering by the user or on an automated default basis. These lists therefore record the order in which the audio-clips and respective number or numbers are used and accessed by the application program.

The tagged-clips are stored in a tagged-clip store (9/1) which is associated with the tagged-clip compiler (7) and the tagged-clip manager (9) either directly or indirectly, such as via a tagged-clip operator (8) as shown in FIG. 2. The tagged-clips may be stored temporarily or permanently in the store. Preferably the system of storage provides the ability to distinguish between any tagged-clip pending use and any tagged-clip post use.

The tagged-clip manager (9) manages and controls the communication of tagged-clips over the communication medium. In this regard, the tagged-clip manager has an auto-dialler (9a), which is configured to activate the automated dialling of any number or numbers within a tagged-clip. Where a tagged-clip has a plurality of numbers to which the audio-clip is to be sent, typically the auto-dialler will dial numbers in the sequence as saved by the list editor (7c). However, the user may decide an alternative sequence at any time prior to auto-dialling.

The tagged-clip manager (9) also has an auto-dial scheduler (9b), which provides means to schedule the operation of the auto-dialler. Preferably this is achieved with reference to a calendar and clock within the application, so that a user can schedule the auto-dialler at a particular future time on a particular day. Alternatively, auto-dialling may be scheduled at pre-set intervals. As shown in FIG. 3, the schedules entitled “ScheduleMaster” and “Schedule Retries” can assist the auto-dial scheduler with this functionality.

Preferably the auto-dial schedule list is viewable by the user on the GUI. In this way the user can amend the scheduled list (i.e. ScheduleMaster), such as by rearranging the order or cancelling any of the entries.

Another feature of the Tagged-clip manager (9) is a dial monitor (9c). The dial monitor monitors a call attempt and determines whether or not the call attempt fails. In this regard, the dial monitor can recognises when a given number is busy or otherwise unavailable. To achieve this, the dial monitor has an integrated ring counter such that when a pre-set or default number of rings to any number is exceeded, the call is automatically terminated. When an attempted call fails, the tagged-clip manager will reschedule the tagged-clip as appropriate (i.e. as per the default re-dialling details, or the user designated re-dialling details as is provided for in the ScheduleMaster in FIG. 3).

Where a given call fails, the auto-dialler may automatically initiate any further calls scheduled or sequential to the failed call, as listed in the AudioClip.

In a vein similar to the auto-dialler and the auto-dial scheduler (9b), the tagged-clip manager (9) also has an auto-redialler and an auto-redialler scheduler (9e), so that where the dial monitor (9c) registers that a tagged clip was not successfully transmitted, it is possible to re-dial the number as appropriate. In this regard, the auto-redialler may automatically redial any number on failure of a given call, or where the call is one of a sequence of numbers, it can redial immediately after the remaining uncalled numbers have been autodialed in their specified sequence.

Alternatively, the redialling may be configured as a single, multiple or continuous redial as specified by the user. For instance, the user may schedule one or more further attempts at particular points in time, or default re-dialling time periods may be defined, such as every ten minutes until the call is answered. An auto-redial scheduler (9e) associated with the auto-redialler (9d) provides the means for enabling the redialling of any terminated or failed calls of a tagged-clip number for any further date and time or at any pre-set interval. Referring to FIG. 3, the schedule entitled “Schedule Retries” lists the number of retries made or to be made in respect of a particular number to be called. In this regard, the scheduled audio-clip had two scheduled attempts on Aug. 7, 2003, one at 9.30AM and the other at 1pm. ScheduleMaster.

A schedule checking program is associated with the main application program. It preferably runs in the background and checks the “ScheduledRetries” table every minute to see if any calls are scheduled and due to be retried.

Further, the auto-redialler may prioritise any one or more failed calls, for example, so that the said call or calls are redialled continuously or at predetermined intervals until answered. With reference to FIG. 3, the “ScheduleMaster” assists with this functionality via the “priority” field. In addition, the auto-redialler may have a manual over-ride and/or a manual operating option.

Where a call connection is made, the tagged clip manager (9) activates the auto-replayer (90. That is, the auto-replayer automatically triggers the replay of any audio-clip or sequence thereof contained with a tagged-clip when a number associated with the tagged-clip is called and answered by the called party. The replay of the audio-clip can be made repeatable.

A replay or call terminator may be associated with the audio-clip replayer, so that there is the optional facility for manual or default termination of any audio-clip communication. For instance, this may occur when a specified single or replay sequence is complete or when any communication is terminated by the called party, so as to ensure that the commencement of further tagged-clip calls which are scheduled are triggered.

Preferably a tagged-clip operator (8) is associated with the tagged-clip manager (9), which provides the user with the ability to override the automatic dialling and re-dialling routine. The tagged-clip operator therefore provides the user with the ability to manually initiate the calls (8a), whether based on default settings (8b) or bespoke settings (8c), at any time following a given tagged-clip compilation.

In addition, associated with the GUI (2a) is a tagged-clip monitor (10), which keeps track of the status of any tagged-clip, so that it can be displayed on the handset's screen and/or logged (10f) for later review. This component of the application program can therefore identify a tagged-clip (10a) being communicated visually on the handset's screen and also provide a status of the tagged-clip's communication, such as “scheduled”, “in progress” (10b), suspended (10c) or terminated (10d). With reference to FIG. 3, the ScheduleMaster can assist with this functionality via the “Status” field. The tagged-clip monitor (10) can also provide a run-timer (10e) so that it is visually possible to determine, for example, who long the tagged-clip has been in progress and/or how much longer the tagged-clip has to play.

The tagged-clip monitor (10) can also be used to display the progress of audio-clip replays (4c). It may also be associated with the alert operator (13) to provide, for example, an audible, visual or vibrational alert upon completion of a tagged-clip communication.

To describe the operation of a mobile handset incorporating the application program according to an embodiment of the invention, reference is to be made to FIG. 4, which shows a flow chart of the procedure for sending tagged-clips to remote devices.

The first step (31) is for the user to obtain an audio clip or clips to be sent to one or more remote devices. This may entail the user selecting an existing audio-clip, such as a pre-recorded message, or the user may record their own audio-clip, such as a voice message.

If a new clip is created, the audio-clip will then be saved with an ID stamp (4a), as controlled by the audio-clip manager. This may be performed automatically, although the user is preferably given an opportunity to personalise the label associated with the audio-clip, such as “Voice Message for Alissa” or “HappyBirthday.wav” and “LateMessage.wav”, as per the examples in FIG. 3.

Where the audio clip selected by the user is an existing one, the user is again preferably given an opportunity to personalise the label associated with the audio-clip. It is also preferable that the selected audio-clip is copied from a read-only memory of pre-recorded clips store to a separate audio-clip store (3), to ensure that the pre-recorded files are available for subsequent use and are not able to be accidentally deleted.

Once the user has obtained the audio-clip or clips, an identifier of a remote terminal or terminals, to which the audio-clip is to be sent, is determined. For instance, the user selects the phone number of the remote terminal to which the clip is to be sent. This is can be performed at the application level using a search engine (15) that searches the number store (5) for the appropriate Number Entry or NumberClip, although the user may simply enter the number manually.

It is to be appreciated that while this embodiment of the invention will be described only in relation to one clip being sent to one remote terminal, multiple clips to multiple different remote terminals, and any other such combination is possible within the inventive concept, as shown in the FIG. 3 example.

With the remote terminal to which the clip is to be sent identified, this identity is associated with the audio-clip, either directly or indirectly. In the FIG. 3 example, the clips and numbers are saved as a file entitled “CallClip1”.

The user may then determine dialling criteria for transmitting the file to the remote terminal. For instance, the user may schedule dialling to take place at 5pm that day and then schedule five reattempts at ten minute intervals thereafter should the call go unanswered or the call fail for whatever other reason. Alternatively a default setting may be implemented.

The selected audio-clip and remote terminal number are linked and stored as a tagged-clip in a tagged-clip store, and the dialling criteria is stored in a schedule associated with the store (9/1). In this regard, where a plurality of tagged-clips are to be sent, they are preferably stored in the schedule in time-order. Other prioritisation may be applied to the schedule, such as by flagging audio-clips as urgent or standard.

The use of the time-based schedule means that the sending of the tagged-clips need not be user initiated, although this can be an option. The ability to schedule a message at a specific time is particularly advantageous when leaving messages in a different time domain, in that a time convenient to the recipient can be scheduled.

Therefore, the application program will monitor a clock associated with the mobile device and the next scheduled time of a tagged-clip to be sent in the linked list. When a match occurs, the application program will retrieve the linked tagged-clip and dial the number of the remote device associated therewith.

A dial monitor will monitor the status of the connection.

Should a connection not be established, the dialling will be terminated, and the tagged-clip rescheduled at a later time for redialling, as determined previously, either by the user or the default settings.

When the dial monitor registers that a connection has been established with a dialled number, the auto-replayer is initiated in order to play the audio-clip associated with the dialled number down the connection. That is the audio-clip is supplied to the transmitter of the handset for transmission across the network connection.

The application program monitors the audio-clip and when it is finished the established communication is disconnected. The audio-clip may be monitored as finished using the time stamp associated therewith.

Where two or more files are to be sent to the one dialled number, instead of disconnecting at the completion of the first audio-clip, the connection is maintained, and the subsequent files retrieved and transmitted.

An example of schedules that can assist with the functionality of the application program components, are shown in FIG. 3.

Firstly, FIG. 3 shows the structure of an example TaggedClip, called CallClip1. CallClip1 contains files made up of a multiple audio messages, termed “Audioclips”, as well as single audio messages, called “Audio Files”. In this example, under the “AudioClip” section, AudioClip1 is saved, which is made up of two messages “HappyBirthday.wav” and “LateMessage.wav”, as well as a single Audio File, which is made up of “Apologise.wav”.

The TaggedClip, CallClip1 also comprises several numbers to which the AudioClips and Audio Files are to be sent. These numbers can be any of three different types. They may be a “Number Entry”, which relates to a number already entered and stored on the phone, a “Number Clip” which relates to a plurality of numbers stored in the phone as a group or they may be a “New Number”, which is a number entered by the user and typically not already stored.

This information can be stored in a number of Schedules. As shown in FIG. 3, the “CallClipMaster” and “CallClipDetails” contain information about the TaggedClip, “CallClip1”. The “CallClipMaster” contains a list of all outstanding TaggedClips. It has two fields, CallClipID and CallClipName. As shown in FIG. 3, with this example, CallClip1 is given the CallClipID of “1” and its name “CallClip1” is entered as the “CallClipName”.

The Schedule “CallClipDetails” is associated with the schedule “CallClipMaster”. In this regard, its first table entry is “CallClipID”, which corresponds with the CallClipID of the CallClipMaster. The other fields in this Schedule are “Type” and “Value”. The “Type” field defines the value, be it an “Audio Clip”, an “Audio File” or a “New Number” etc.

In the type field, “N” stands for a “New Number”, NE stands for a “Number Entry”, NC stands for a “Number Clip”, AC stands for an “Audio Clip” and AF stands for an “Audio File”.

Referencing back to the structure of CallClip1 given in FIG. 3, this TaggedClip contained two new numbers, being “55555555555” and “6666666666”. These two new numbers are therefore stored in the “CallClipDetails” schedule as type “N” and with values “55555555555” and “6666666666” respectively.

CallClip1 also has two “Number Entries”, being Number Entries 8 and 3. These are stored in the CallClipDetails schedule as type “NE” with values 8 and 3 respectively. These “Number Entries” reference an actual phone number in the phone's memory.

CallClip1 also has one Number Clip, being NumberClip 6. This is therefore stored in the CallClipDetails schedule as type “NC” and value “6”.

CallClip1 also has one Audio Clip, being AudioClip1. This is therefore stored in the CallClipDetails schedule as type “AC” and value “1”.

Finally, CallClip1 also has one Audio File, being “Apologize.wav”. This is therefore stored in the CallClipDetails schedule as type “AC” and value “Apologize.wav”.

With this TaggedClip saved as such, it is also necessary to associate the TaggedClip with scheduling details for the Audio Clips and Files to be communicated to the designated numbers. In this regard, the ScheduleMaster contains the fields “ScheduleID”, “Redials”, “Rings”, “Status and “Priority”.

The ScheduleID can be the same as the CallClipID, in that it refers to the taggedclip as a whole or it can refer to specific audio-clips or files within the tagged clip. The “Redials” field defines the number of times the TaggedClip Manager (9) will attempt to connect with the party to be called, such that in the event of the number being busy or going unanswered. The “Rings” field defines the number of rings to be made until the attempted connection is considered unanswered. The “Status” filed indicates, for instance, whether call is “scheduled”, or underway. The “priority” filed allows a person to designate some calls as more important than others.

The TaggedClip Manager (9) would therefore use the information in these schedules (as well as other schedules) and update as appropriate.

For instance, the Dial Monitor (9c) component of the TaggedClip Manager would continually poll the “ScheduledRetries” table to find any record which has its “Date-Time” value in the past and its corresponding record in the “ScheduleMaster” table has the status as “scheduled”, or “waiting to retry”. As soon as it finds any such record, it changes the status of the record in the “ScheduleMaster table to “In progress”.

The Dial Monitor (9c) then dials the numbers from “CallClipDetails” table one after the other. IF there are any numbers which have not been dialled successful, it redials the failed numbers. But before redialling the failed numbers it changes the status of the record in the “ScheduleMaster” table to “Waiting for Redial” and picks up another schedule for processing.

If all the numbers are dialled successfully in the first attempt, or in the redials, then the status of the record in ScheduleMaster is changed to “Success”.

If all the numbers are not dialled successfully in the first attempt or subsequent redials, the “ScheduleRetries” table is checked to see whether any retry entries for that current schedule are specified. IF there is a retry entry, then it changes the status of the record in the ScheduleMaster table to “Waiting for Retry”. If there is no retry entry specified, then it changes stats of the record in the ScheduleMaster table to “Failed”.

According to a further embodiment of the invention, rather than disconnecting at the completion of the playing of the audio-clips, the application program allows the called party to respond to the message. That is, the application program can prompt the called party to record a reply, if desired. The application would then start recording any spoken reply by the called party across the connection.

Further, according to another embodiment, each time a connection is established, a fixed message is communicated across the connection before the audio-clip is communicated. This enables the application program to address the situation where an answering machine picks up at the other end, rather than a person, and has an automated message before allowing recording to commence, particularly since the mobile handset on which the application is configured cannot necessarily do so. The length of the fixed message should be selected in order to maximise the likelihood of the personal message being recorded in full.

Therefore the length of the fixed message should be strategically determined on the basis of the maximum length of answering machine messages. Therefore, even if an answering machine starts its replayed message, it is likely that it will be the playing of the fixed message that corresponds therewith, and that the answering machine's message will be exhausted in time for the personal message to still be recorded. According to a further embodiment, the fixed message could be played before the personal message, and then this combination again repeated. In this way the personal message should be recorded in full at least once on the answering machine.

An alternative feature, which also addresses the answering machine problem is to introduce a delay to the delivery of the message when it is detected that an answering machine has answered rather than a person. The delay is intended to postpone the playback until the answering machine has finished delivering its own message and recording started.

A further feature that an embodiment of the present invention may provide is that of call interruption. That is, the application program can allow incoming calls to override outgoing schedules and also allow outgoing calls to override outgoing schedules. This feature is important when it is considered that the nature of the present invention implemented on a mobile phone means that a balance needs to be struck between the usage of the mobile phone for its normal purposes and for transmission of the audio-clips, particularly since a dedicated line is not normally provided.

An additional feature that an embodiment of the present invention may provide, once a call is established, is for the microphone on the caller's phone to be muted. This is so that the called party doesn't receive any sounds from the calling phone, apart from the audio-clip itself. It is also preferable that the speaker on the caller's phone is muted, so that the calling party does not hear the outgoing message.

On a Nokia 7650 phone, this can be achieved by using the inbuilt functionality of the device. In this regard, when the call is connected, a Nokia 7650 phone opens up a default window known as the “Call Window”. The Call Window has its own menu items, one of which is “Mute”. Therefore, once this window is opened, the application program sends a series of key-strokes to select the “Mute” menu item. Once selected, this function serves to mute the phone by switching off the microphone, so that the called device hears no external sound. This muting, however does not affect the called device hearing the audio-clips played across the connection.

The procedure just described specifically relates to the Nokia 7650. For other phones, equivalent functionality would need to be achieved.

As mentioned previously, the application program of this embodiment, where possible, makes use of the existing facilities of the phone, including the phone's operating system. To illustrate this, an example of the implementation of the dial monitor, where the Symbian operating system is utilised, will be described. The dial monitor functionality can be achieved using the existing functionality of Symbian. More specifically, Symbian provides the mechanisms of Active Scheduler and Active Objects. Active Objects are present inside the Active Scheduler and can be used to make an asynchronous request, like dialling a number. As soon as any Active Object makes an asynchronous request, Active Scheduler takes over the control for monitoring the status of that asynchronous request. When the asynchronous request is completed, Active Scheduler informs the Active Object which made the request, of the completion of the request.

In this way, the dial monitor can use the Active Object and Active Scheduler to dial the number, monitor the status of the call and hang up the call.

Therefore, when the dial monitor has to dial a number it opens the voice line and requests an Active Object to dial the number. The Active Object passes that request on and the number is dialled through telephony APIs (Application Program Interfaces) provided by Symbian. At this point the Active Scheduler starts monitoring for the completion of the request.

When dialling is complete, either successfully or unsuccessfully, Active Scheduler informs the Active Object of the same. While doing so, it passes the status of the dialling to the Active Object. The application program of the present embodiment is then able to utilise this status for its own further processing.

For instance, if the status is “connected” then the application program plays the audio message. If the status is “unknown” then the application program hangs up the call.

It is to be appreciated that opening of the audio file, playing of the audio file and closing of the audio file are other functions that can be undertaken within an active object. Therefore, the statuses of audio files being played can be monitored in the same way as the line connection process.

Once all the audio files have been played, the Active Object makes an asynchronous request to the device to hang up the call. At this point the Active Scheduler starts monitoring for the completion of the hang-up request. As soon as the call has been hung up, the Active Scheduler informs the Active Object of the same, along with the status of the hang-up request. The Active Object then closes the voice line when it has been notified that the call has been hung-up.

Alterations and additions are possible within the general inventive concepts. The embodiments of the invention are to be considered as illustrations of the inventions and not necessarily limiting on the general inventive concepts.

For example, the present invention has been described in relation to a GSM/GPRS enabled phone, but any other mobile terminal may be used, provided its memory requirements are sufficient to support an application program embodying the invention. In practice, it has been found that at least a 2.5G to 3G mobile handset is required. Personal Digital Assistants (PDAs) and other such devices able to access mobile communications networks may also be configured to utilise the present invention.

Further, the embodiments of the invention have described only one call connection being established to transmit the tagged-clips at one time. While this most typically within the capabilities of existing handsets, it is not outside the scope of the invention to establish multiple connections at one time.

Also, the components as described in the preferred embodiments provide only an example of how a mobile terminal may be configured to perform the functional aspects of the invention.

The skilled person will appreciate that the precise implementation of the application program of the present invention will depend on the application program interfaces (APIs) utilised. This is because different APIs, which are the specific methods prescribed by a computer operating system by which a person writing an application program can make requests of the operating system or another application, will be utilised for different operating systems.

The skilled person will recognise that the above-described apparatus and methods may be embodied as processor control code, for example on a carrier medium such as a disk, CD- or DVD-ROM, programmed memory such as read only memory (Firmware), or on a data carrier such as an optical or electrical signal carrier. For many applications embodiments of the invention will be implemented on a DSP (Digital Signal Processor), ASIC (Application Specific Integrated Circuit) or FPGA (Field Programmable Gate Array). Thus the code may comprise conventional programme code or microcode or, for example code for setting up or controlling an ASIC or FPGA. The code may also comprise code for dynamically configuring re-configurable apparatus such as re-programmable logic gate arrays. Similarly the code may comprise code for a hardware description language such as Verilog™ or VHDL (Very high speed integrated circuit Hardware Description Language). As the skilled person will appreciate, the code may be distributed between a plurality of coupled components in communication with one another. Where appropriate, the embodiments may also be implemented using code running on a field-(re)programmable analog array or similar device in order to configure analog hardware.

The skilled person will also appreciate that the various embodiments and specific features described with respect to them could be freely combined with the other embodiments or their specifically described features in general accordance with the above teaching. The skilled person will also recognise that various alterations and modifications can be made to specific examples described without departing from the scope of the appended claims.

I claim:

1. A mobile communication device for the communication of at least one audio file to a remote communication device over a communication network, the device comprising:
means for associating the at least one audio file with an identifier of the remote communication device;
means for seeking and establishing a voice connection with the remote communication device via the identifier; and
means for playing the associated audio file across the connection, upon establishing a connection with the remote communication device;
the device being configured for telephonic voice communication over the communications network and further comprising a microphone for the telephonic voice communication, and means for muting the microphone upon the device establishing the connection with the remote communication device.

2. The device of claim 1 wherein the identifier of the remote communication device is a phone number.

3. The device of claim 2 wherein the means for seeking a connection includes a means to automatically dial the phone number of the remote communication device at a predetermined time.

4. The device of claim 3 further comprising means for listing a plurality of remote communication device numbers, each associated with one or more audio files, for sequentially dialling the remote communication device numbers.

5. The device of claim 1 wherein the means for seeking a connection comprises means for terminating an attempted call if unanswered.

6. The device of claim 5 wherein the code for seeking a connection further comprises means for rescheduling terminated call attempts.

7. The device of claim 1 wherein the device further comprises means for recording audio files.

8. The device of claim 1 wherein the program code further comprises code for ending the connection upon completion of the played audio file or files.

9. The device of claim 1 further comprising a speaker for monitoring the audio file as it is played across the connection, and means for muting the speaker selectively.

10. A method of enabling a mobile communication device to communicate an audio file to a remote communication device, the communication device having a microphone for telephonic voice communication, the method comprising:
associating the audio file with an identifier of the remote communication device;
establishing a voice connection with the remote communication device using the identifier and,
upon establishing the voice connection, playing the audio file across the connection, and muting the microphone during the playing of the audio file.

11. A method of configuring a mobile communication device for communication of audio files over a communications network via the download of program code, the communication device having a microphone for telephonic voice communication, the method comprising:
storing the program code in a memory of the mobile communication device;
obtaining an audio file;
linking the audio file with an identifier associated with a remote receiving communication device;
seeking to establish a voice connection with the remote receiving communication device using the identifier, and
upon establishing a voice connection with the remoter communication device, opening the audio file from the memory of the mobile communication device and playing the audio file to the remote communication device while muting the microphone.

12. The method of claim 10 wherein the audio file is associated with identifiers for a plurality of different remote communication devices.

13. The method of claim 10 wherein the identifier of the remote communication device is associated with a plurality of audio files.

14. A carrier medium comprising processor readable code for controlling a processor in a mobile communications device having a microphone for telephonic voice communication, in order to enable the device to communicate an audio file to a remote communication device, according to the following method:
obtaining an audio file;
linking the audio file with an identifier associated with the remote communication device;
seeking to establish a voice connection with the remote communication device using the identifier, and
upon establishing a voice connection with the remote communication device, opening the audio file and playing the audio file to the remote communication device while muting the microphone.

15. The carrier medium according to claim 14 wherein the step of obtaining an audio file comprises recording the audio file as a voice file using the microphone.

16. The carrier medium according to claim 14 wherein the step of obtaining the audio file comprises extracting the file from a memory store.

17. The carrier medium according to claim 14 wherein obtaining the audio file comprises combining a plurality of stored audio files.

18. The carrier medium according to claim 14 wherein the identifier is a phone number.
